(19) United States
(12) Patent Application Publication
(10) Pub. No.: US 2023/0251983 A1
(43) Pub. Date: Aug. 10, 2023

(54) HYBRID ASYNCHRONOUS NETWORK-ON-CHIP OPTIMIZED FOR ARTIFICIAL INTELLIGENCE WORKLOADS

(71) Applicant: Chronos Tech LLC, San Diego, CA (US)

(72) Inventors: Stefano Giaconi, San Diego, CA (US); Giacomo Rinaldi, San Diego, CA (US); Matheus Gibiluka, San Diego, CA (US); David Fong, San Diego, CA (US)

(21) Appl. No.: 18/106,476

(22) Filed: Feb. 6, 2023

Related U.S. Application Data
(60) Provisional application No. 63/306,811, filed on Feb. 4, 2022.

(51) Int. Cl. G06F 13/20

(52) U.S. Cl. CPC G06F 13/20; G06F 2213/40

(57) ABSTRACT

A hybrid asynchronous network-on-chip (NoC) optimized for artificial intelligence workloads utilizes a “tile” layout methodology with a plurality of tiles, each tile including an asynchronous node with a plurality of input ports and output ports for communicating with adjacent asynchronous nodes on adjacent tiles, along with a processor input port and processor output port configured to transport data from an asynchronous processor, but capable of being customized to transport data between a synchronous processor through the implementation of modular synchronous-to-asynchronous and asynchronous-to-synchronous first-in-first-out (FIFO) buffers. The asynchronous NoC is able to efficiently satisfy the interconnect traffic requirement of modern machine learning systems, eliminating the need for a global clock distribution and enabling unlimited scalability while providing high throughput and minimal latency performance.

### RELATED APPLICATIONS INFORMATION

This present application claims the benefit of priority under 35 U.S.C. 119(e) to U.S. Provisional Patent Application Ser. No. 63/306,843, filed Feb. 4, 2022, and U.S. Provisional Patent Application Ser. No. 63/306,811, filed Feb. 4, 2022, now U.S. Non-Provisional patent application Ser. No. 18/106,475, filed Feb. 7, 2023 the contents of which are incorporated herein in their entirety.

### BACKGROUND

### 1. Technical Field

The various embodiments described herein are related to application specific integrated circuits (ASICs), and more particularly to a network-on-chip (NoC) for use with synchronous and asynchronous processing units.

### 2. Related Art

Continuing advances in semiconductor device fabrication technology have yielded a steady decline in the size of process nodes. For example, 7 nanometer (nm) process nodes were introduced in 2017 but were quickly succeeded by 5 nm nm fin-field-effect-transistors (FinFETs) in 2018 while 3 nm gate-all-around-field-effect-transistors (GAAFETs) process nodes are projected for commercialization by end of 2022.

The decrease in process node size allows a growing number of intellectual property (IP) cores or IP blocks to be placed on a single ASIC chip. Latest ASIC designs often use a comparatively large silicon die and include combinations of independent IP blocks and logic functions. At the same time, modern applications also require increased connectivity and large data transfers between various IP blocks. The vast majority of modern ASIC chips are heterogenous systems to enable optimization of performance and power figures for the numerous IPs, as well as multi-core implementations, leading to a very complicated interconnect sub-system.

All indications point to even higher levels of integration and data processing in further system-on-chips (SoCs) in the year to come. This will allow even more functions to be added, making systems more complex, more intelligent, more power efficient while putting even more pressure on the interconnect fabric.

Interconnect fabrics have changed over time to address requirements of evolving systems. Traditional busses (such as AMBA AHB) have evolved over time, to more intelligent crossbars and later hierarchical crossbars which enabled faster data switching among multiple ports or port domains. Once the number of buses and data width grew to an unmanageable amount, the industry responded with more flexible packetized approach (as it was done previously for computer hardware networks) through the development of network-on-chips (NoCs).

Modern SoCs for artificial intelligence (AI) and machine learning (ML) require high throughout and most importantly low latency architectures. Data must move between GPUs, TMUs or CPUs and the memory system with minimum latency, because most of the operations use a very large amount of data and repeated linear matrices operations.

A common AI system architecture is composed of a large repetitive array of “tiles” which include a processing unit (PU) and a router. In order to reduce latency, the tiles are built with minimum space between them (usually the area is dominated by the PU and local memory element), and the maximum clock frequency of the router is dictated by the RC of the interconnect. Usually a “single jump” (no pipelining) is used between routers to minimize latency and thereby maximize data exchange. The drawback of such an architecture lays on the fact that the router itself will use several clock cycles to steer the signal to the right port, and operating on a reduced clock frequency compromises latency performance of the whole system.

Therefore, improvements are needed to overcome the fundamental bottleneck found in the aforementioned conventional approach to AI system design, as well as a way of routing the information among the different PU and memory systems efficiently and with minimized latency.

### SUMMARY

Embodiments herein provide devices and methods for ASIC design, including an asynchronous network-on-chip (NoC) optimized for artificial intelligence workloads utilizing a “tile” layout methodology where each tile includes an asynchronous node which transports data between asynchronous nodes on adjacent tiles, and where each asynchronous node is configured to communicate with either an asynchronous processor or synchronous processor, the connection between the asynchronous node and synchronous processor facilitated by a pair of modular first-in-first-out (FIFO) buffers capable of converting synchronous data to asynchronous data and asynchronous data to synchronous data.

In one embodiment, an asynchronous network-on-chip comprises: a plurality of intellectual property (IP) blocks arranged on individual adjacent tiles; an asynchronous node positioned on each of the plurality of IP blocks; a plurality of input ports and output ports located on each asynchronous node and configured for communicating with adjacent asynchronous nodes on adjacent tiles; and a processor input port and a processor output port located on each asynchronous node and configured for communicating with a processing unit.

In another embodiment, a method for fabricating an asynchronous network-on-chip comprises the steps of: arranging a plurality of intellectual property (IP) blocks on individual adjacent tiles; positioning an asynchronous node on each of the plurality of IP blocks; forming a plurality of input ports and output ports on each asynchronous node, the plurality of input ports and output ports configured for communicating with adjacent asynchronous nodes on adjacent tiles; forming a processor output port on each asynchronous node, the processor output port configured for transmitting data to a processing unit; and forming a processor input port on each asynchronous node, the processor input port configured for receiving data from the processing unit

Other features and advantages of the present inventive concept should be apparent from the following description which illustrates by way of example aspects of the present inventive concept.

### BRIEF DESCRIPTION OF THE DRAWINGS

The above and other aspects and features of the present inventive concept will be more apparent by describing example embodiments with reference to the accompanying drawings, in which:

FIG. 1 is a block diagram illustration of an asynchronous Network on Chip (NoC) optimized for a machine learning (ML) workload, according to one embodiment of the invention;

FIG. 2 is a block diagram illustration of an artificial intelligence (AI) NoC tile with an Asynchronous Processing Unit (APU), according to one embodiment of the invention;

FIG. 3 is a block diagram illustration of the AI NoC tile with a Synchronous Processing Unit, according to one embodiment of the invention;

FIG. 4 is a block diagram illustration of an AI Mesh Node, according to one embodiment of the invention;

FIG. 5 is a block diagram illustration of an AI Router, according to one embodiment of the invention;

FIG. 6A is a block diagram illustration of a multi-die NoC optimized for ML workloads with APU NoC tiles, according to one embodiment of the invention;

FIG. 6B is a block diagram illustration of the multi-die NoC with the SPU NoC tile and APU NoC tiles, according to one embodiment of the invention;

FIG. 7 is a block diagram illustration of an Asynchronous Input Port, according to one embodiment of the invention;

FIG. 8 is a block diagram illustration of an Asynchronous Output Port, according to one embodiment of the invention;

FIG. 9 is a block diagram illustrating a method of fabricating a NoC optimized for machine learning, according to one embodiment of the invention; and

FIG. 10 is a block diagram that illustrates a computer-embodied system, according to various embodiments.

### DETAILED DESCRIPTION

Embodiments herein provide devices and methods for ASIC design, including an asynchronous network-on-chip (NoC) utilizing a “tile” layout methodology where each tile includes an asynchronous node which transports data between asynchronous nodes on adjacent tiles, and where each asynchronous node is configured to communicate with either an asynchronous processor or synchronous processor, the connection between the asynchronous node and synchronous processor facilitated by a pair of modular first-in-first-out (FIFO) buffers capable of converting synchronous data to asynchronous data and asynchronous data to synchronous data.

The asynchronous NoC described herein is optimized for artificial intelligence workloads and can efficiently satisfy the interconnect traffic requirements of modern machine learning systems, eliminating the need for a global clock distribution and enabling unlimited scalability while providing high throughput and minimal latency performance. Additionally, the implementation of the modular FIFO buffers allows a hybrid NoC capable of utilizing synchronous processing units on individual tiles while maintaining the asynchronous NoC by converting the synchronous data to asynchronous data (and vice versa) at the connection point of the processing unit and node.

While certain embodiments are described, these embodiments are presented by way of example only, and are not intended to limit the scope of protection. The methods and systems described herein may be embodied in a variety of other forms. Furthermore, various omissions, substitutions, and changes in the form of the example methods and systems described herein may be made without departing from the scope of protection.

The embodiments described herein provide a network-on-chip (NoC) optimized for artificial intelligence (AI) workloads by efficiently satisfying the interconnect traffic requirement of modern machine learning (ML) systems, eliminating the need for a global clock distribution and enabling unlimited scalability, while providing high throughput and minimal latency.

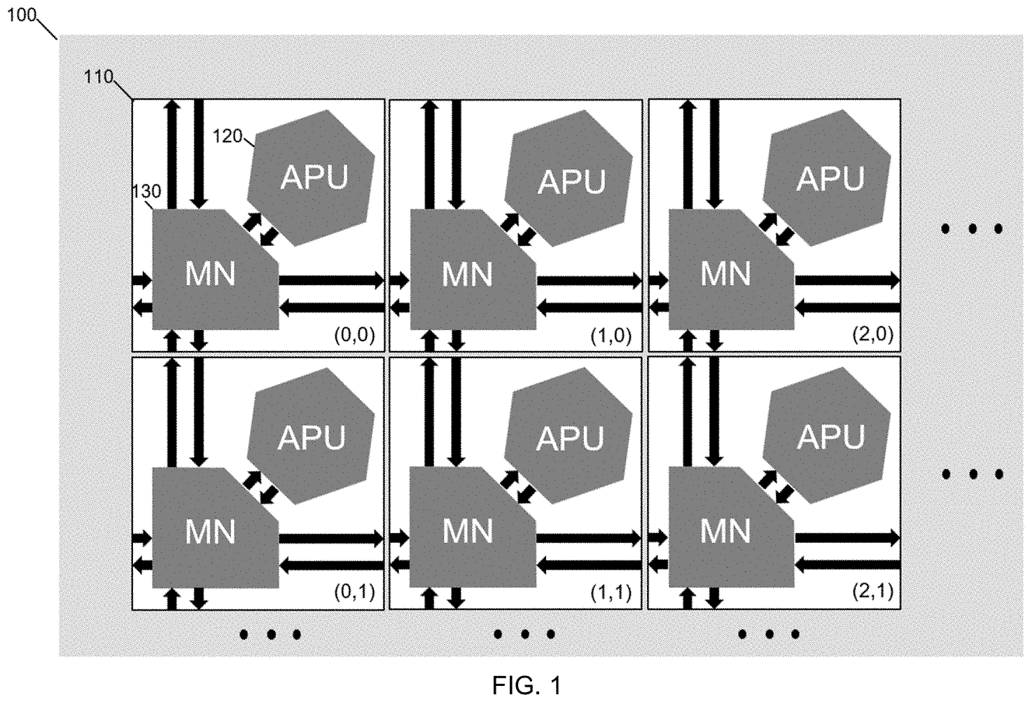

FIG. 1 is a block diagram illustration of one embodiment of a possible implementation of an AI NoC (100). To leverage the repetitive nature of the IP, the NoC (100) is designed using a “tile” approach by repeating the tile in a pattern. In this embodiment, each tile (110) is the same, and the tiles are arranged in a multidimensional array (X,Y), but it can also be any dimension. Each tile (110) is an intellectual property (IP) block which includes a Mesh Node (Router) (130) which takes care of routing the data asynchronously between other nodes, and an input port and output port configured to communicate with an Asynchronous Processing Unit (APU) (120). In this embodiment, the entire NoC (100) is asynchronous. Although FIG. 1 illustrates the overall system of the NoC with the IP block inclusive of the mesh node (130) and processor (120), this overall system inclusive of the processing unit is commonly referred to as an Accelerator, as opposed to the NoC (100), which is described herein as exclusive of the processing unit elements.

The advantage of the entirely asynchronous NoC (100) of FIG. 1 is the elimination of any dependency on the traditional clock-driven synchronous NoC which relies upon a clock to manage the movement of data from the processor to the mesh node, as well as from one mesh node to an adjacent mesh node. By utilizing an asynchronous design throughout, the limitations of the typically slow CPU clock are avoided. In one situation, this asynchronous NoC has been shown to improve processing by approximately 30 percent.

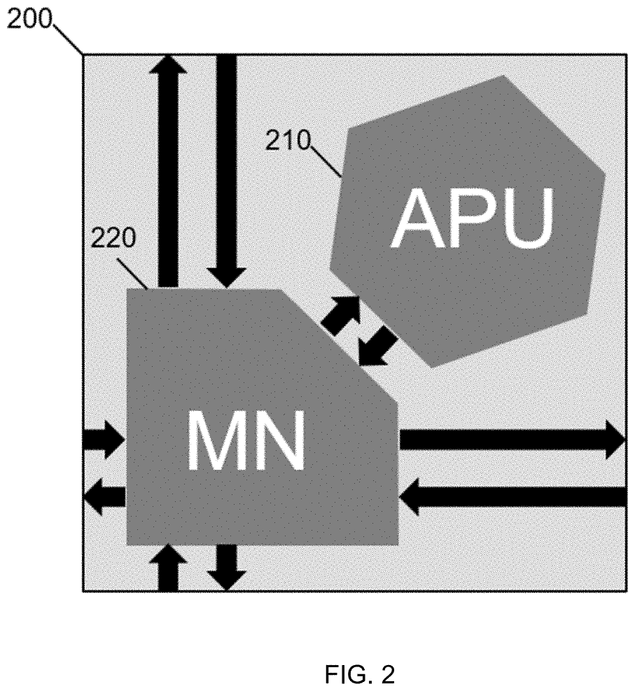

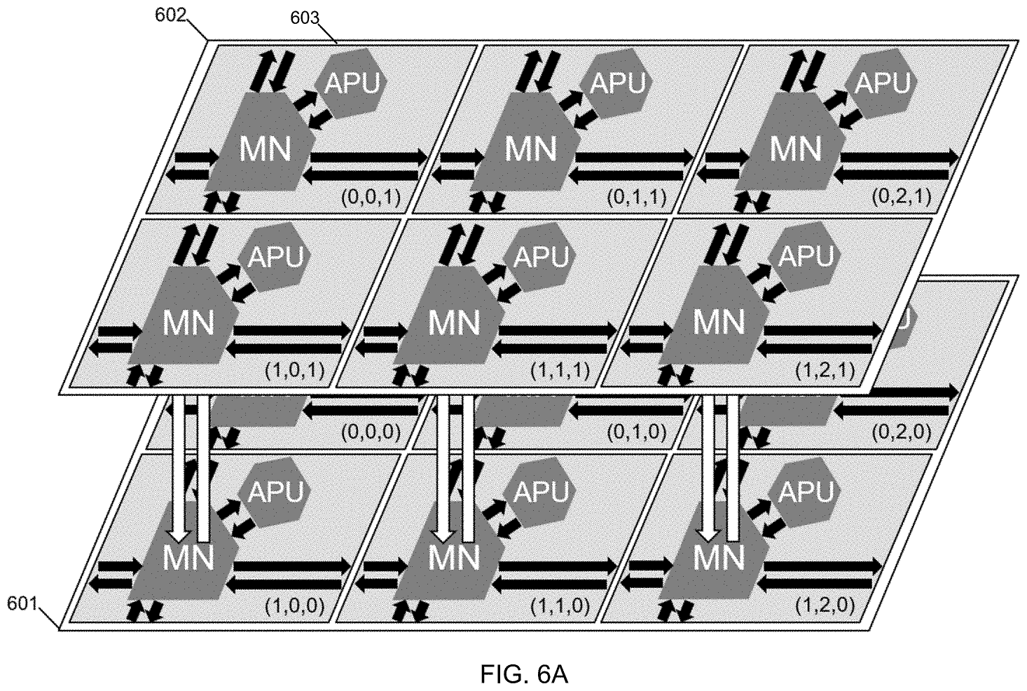

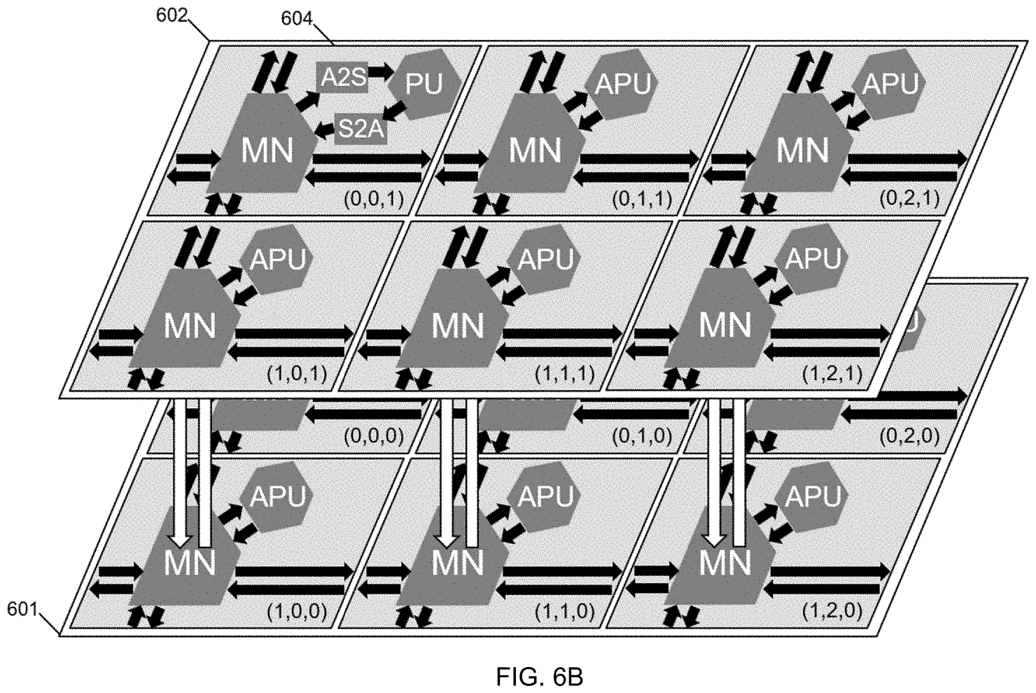

FIG. 2 is a block diagram illustration of one embodiment of the tile (200) from FIG. 1, including a 5-port asynchronous mesh node (220) directly connected to the Asynchronous Processing Unit (210) previously shown in the tiles (110) of FIG. 1. The asynchronous mesh node (220) communicates with the APU (210) via a processor output port and processor input port, as shown by the directional arrows connecting the two elements. The other ports connect the mesh node (220) with adjacent tiles (110), as shown in FIG. 1, and it can be appreciated that the mesh node (220) could be implemented with as few as 2 ports or as many as 7 ports in a three-dimensional NoC, depending on the overall structure of the NoC (as shown in FIG. 6, below), but in some cases even more than 7 if bypass nodes are used. This tile configuration allows for bidimensional routing of data without the need of any high-speed clock distribution. There is no need to resynchronize data within the tile or between tiles, accelerating the data flow and minimizing latency. This configuration also enables easy power and performance scaling with voltage island control.

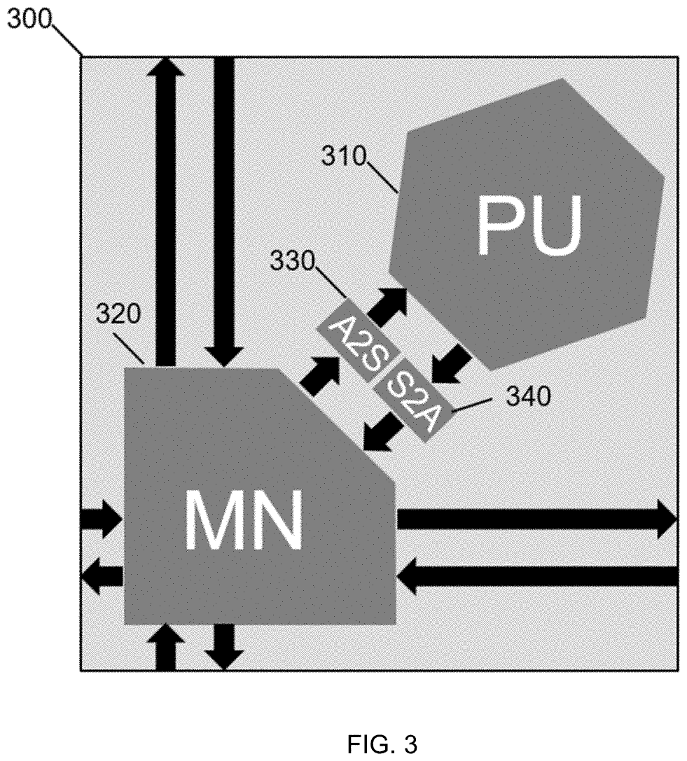

While designing a NoC to be entirely asynchronous has advantages, there are still circumstances where synchronous processing may be needed. However, previous limitations require the NoC to be either entirely synchronous or entirely asynchronous. To resolve this issue, a modular first-in-first-out (FIFO) buffer can be used to convert synchronous data to asynchronous data, or asynchronous data to synchronous data, allowing each tile to be individually customized as either synchronous or asynchronous. FIG. 3 is a block diagram illustration of one embodiment of a FIFO-embedded tile (300) with a 5-port asynchronous mesh node (320) connected with a Synchronous Processing Unit (SPU) (310) via a pair of FIFO buffers: an asynchronous-to-synchronous FIFO (330) and a synchronous-to-asynchronous FIFO (340). This configuration allows for easy reuse of existing synchronous processing units, while still leveraging the low latency nature of the asynchronous mesh node (320). In this case, the SPU can run at a very high-speed clock. As with the asynchronous NoC in FIG. 1, each tile can virtually run at a different clock speed, because the mesh connecting them is fully asynchronous even when the individual processing units on one or more tiles may be synchronous. To enable synchronization between the synchronous and asynchronous domains, a Synchronous-to-Asynchronous (S2A) circular FIFO (340) and an Asynchronous-to-Synchronous (A2S) circular FIFO (330) are positioned between the SPU (310) and the mesh node (320). These FIFO buffers are described in more detail below.

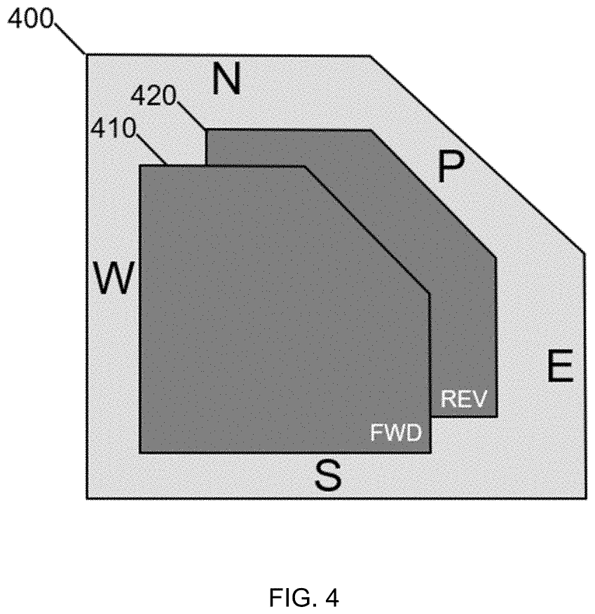

FIG. 4 is a block diagram of one embodiment of the Mesh Node (130) described above in FIGS. 1-3. To minimize routing congestion and improve performance, each Mesh Node (400) may be composed of two individual Asynchronous Routers (410, 420): a forward router (410) to direct data traffic in the forward data path and a reverse router (420) to steer data in the reverse data path (also called the response data path). The two routers can use independent routing strategies to maximize performance while minimizing power. Although the Mesh Node (400) comprises two separate routers, for purposes of simplicity they are illustrated throughout this description as a single Mesh Node (MN).

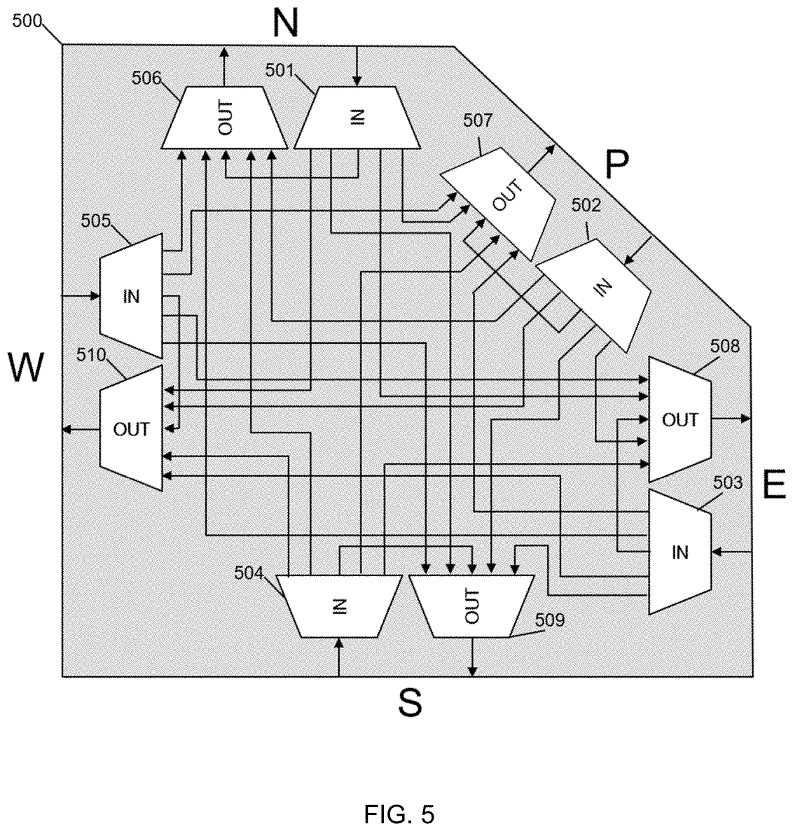

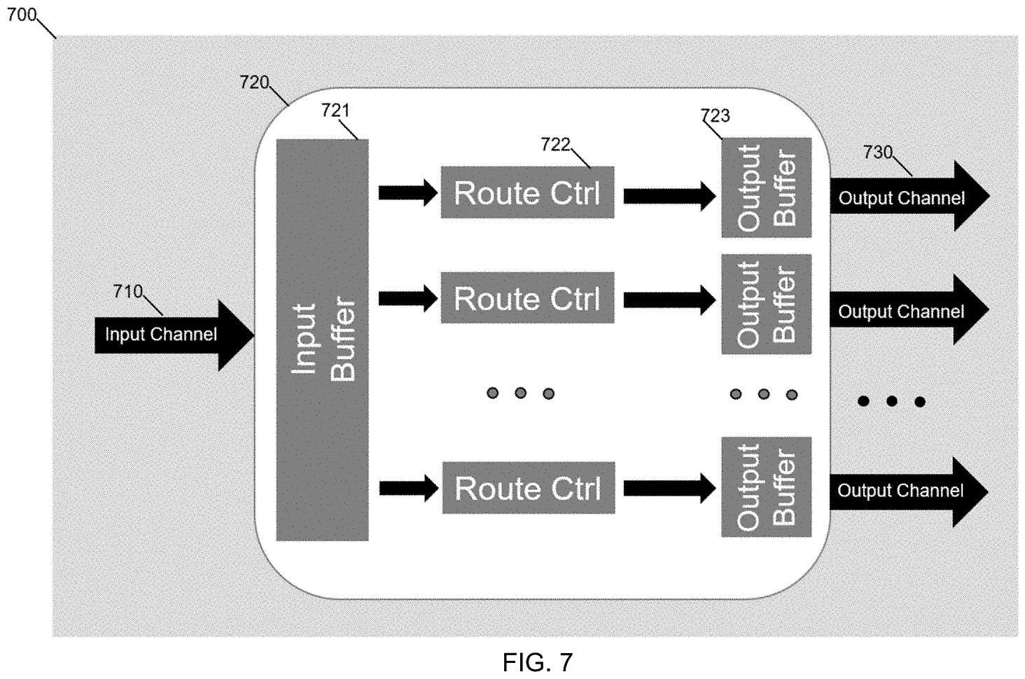

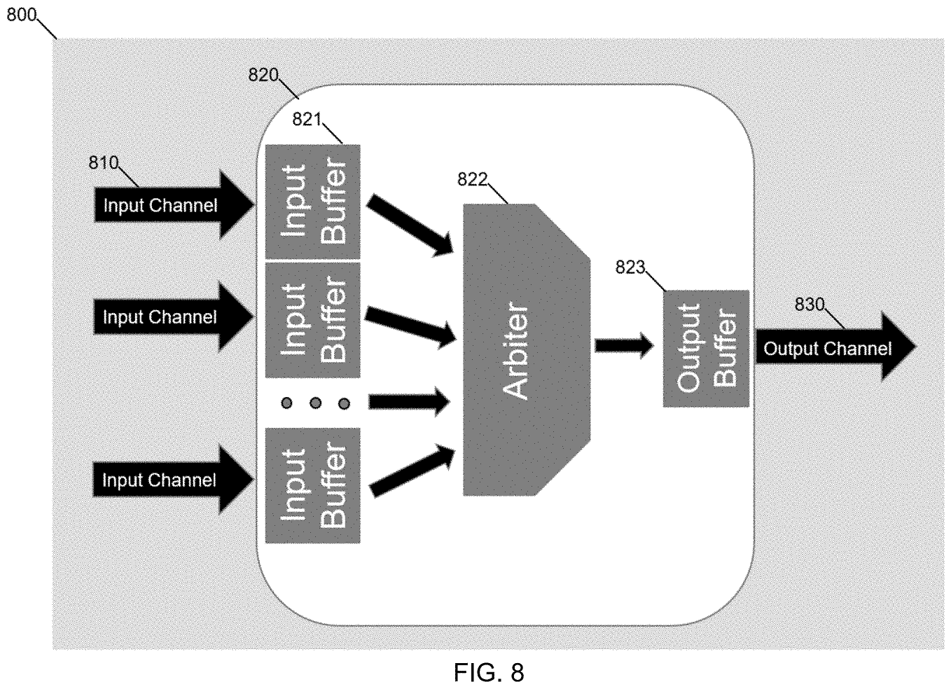

FIG. 5 is a block diagram illustrating connection paths within the 5-port asynchronous mesh node (router) (220) in FIG. 2. In this embodiment, the Asynchronous 5-port Node (500) is depicted for use in a two-dimensional (2D) mesh NoC architecture. Other configurations are also available to provide different network architectures, such as a 3D mesh, 2D-Torus, Ring, etc. Configurations with extra ports in the router to allow for node skipping (sometimes called “rushing”) can also be used. The Asynchronous Node (500) is built by combining Asynchronous Input Ports (501-505) and Asynchronous Output Ports (506-510). The input and output ports can be designed using either a Bundled Data template or a QDI template, and different templates can be used on different ports. Further details of the configuration of the Asynchronous Input Ports and Asynchronous Output Ports can be found below with regard to FIG. 7 and FIG. 8.

Furthermore, as noted above, each node within a NoC can have a different number of ports to allow for reduced power consumption (i.e., a node located on a left edge of a die can have a West (W) port removed) or to enable routing to a different plane (3D routing), as shown immediately below with regard to FIG. 6A and FIG. 6B.

FIG. 6A is a block diagram illustrating one embodiment of a three-dimensional AI NoC. In this case, two independent dies (601, 602) are connected through an electrical physical connection (such as Hybrid Bonding, TSVs, micro-bumps, silicon interposer, organic substrate, etc.). Extra vertical ports in the asynchronous mesh node of each tile (603) expand the bidimensional structure of the mesh node to a multi-dimensional NoC. Leveraging the asynchronous properties of the nodes as well as the serialization/deserialization feature of the Chronos channels (described in U.S. Pat. Nos. 9,977,852 and 10,235,488) enables higher tolerance to PVT as well as savings in precious 3D routing resources.

FIG. 6B is a block diagram illustration of one embodiment of the three-dimensional AI NoC from FIG. 6A, but with a Synchronous Processing Unit (SPU) tile (604) from FIG. 3 incorporated within the die (602) alongside other APU tiles. As described in FIG. 3, the use of A2S and S2A circular FIFO buffers allow an SPU tile (604) to be implemented on an otherwise asynchronous die (602) with asynchronous mesh nodes.

FIG. 7 is a block diagram of one embodiment of an operation (700) of an Asynchronous Input Port (720) as initially referenced above with regard to FIG. 5 (501-505), where an asynchronous input channel (710) gets routed to one or more asynchronous output channels (730). The AIP (720) is composed of an Input Buffer (721) with multiple outputs, enabling multi-cast operation for a one-to-many routing optimization. It is followed by Route Controllers (722) which take care of directing the signal to the appropriate node, and which also take care of masking addresses unreachable by a certain routing algorithm (to avoid delivering the same packet more than once). The last component in the operation (700) is an optional Output Buffer (723) for throughput optimization, virtual channels or wormhole operations.

FIG. 8 is a block diagram illustration of an operation (800) of an Asynchronous Output Port (820) as initially referenced above with regard to FIG. 5 (506-510), where multiple input channels (810) are arbitrated to a single output channel (830). It is composed of an optional Input Buffer (821) for throughput optimization, or virtual channel operations, followed by an Arbiter (822) which selects a “winning” channel, and finally an Output Buffer (823) to store the data before being transmitted via the output channel (830).

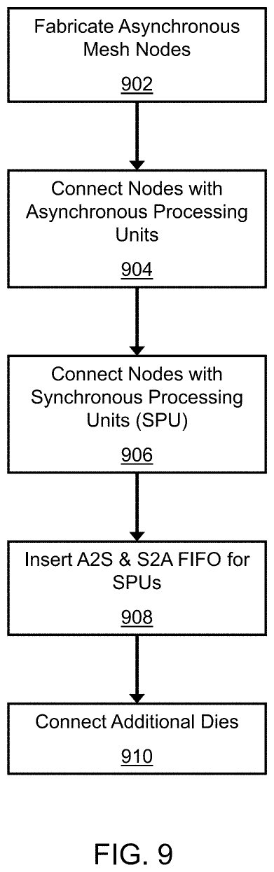

FIG. 9 is a block diagram illustrating a method of designing a NoC optimized for machine learning, according to one embodiment of the invention. A plurality of asynchronous mesh nodes are fabricated (step 902) and connected with asynchronous processing units (step 904) or synchronous processing units (step 906) on individual tiles of a die, the latter situation requiring the insertion of an Asynchronous-to-Synchronous (A2S) FIFO Buffer and Synchronous-to-Asynchronous (S2A) FIFO Buffer (step 908) between the asynchronous mesh nodes and the synchronous processing units. The die may then be connected with other dies (step 910) to create a multi-dimensional network-on-chip (AI NoC) optimized for artificial intelligence and machine learning.

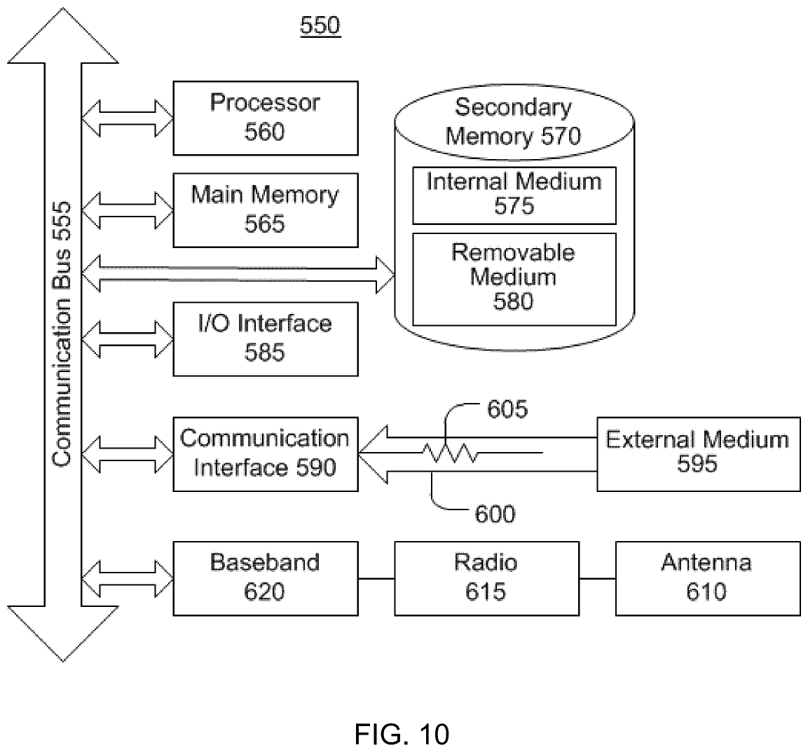

FIG. 10 is a block diagram illustrating a wired or wireless system 550 according to various embodiments. Referring to FIGS. 1-9, the system 550 may be used to implement the FIFO embedded NoC.

In various embodiments, the system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPM”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, the secondary memory 570 may include other similar means for allowing computer programs or other data or instructions to be loaded into the system 550. Such means may include, for example, an external storage medium 595 and a communication interface 590. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are the removable medium 580 and a communication interface , which allow software and data to be transferred from an external storage medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. The electrical communication signals 605 are preferably provided to communication interface 590 via a communication channel 600. In one embodiment, the communication channel 600 may be a wired or wireless network, or any variety of other communication links. Communication channel 600 carries the electrical communication signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The processor 560 has access to one or more data storage areas including, for example, but not limited to, the main memory 565 and the secondary memory 570. The processor 560 is preferably configured to execute instructions (i.e., computer programs or software) that can be stored in the main memory 565 or in the secondary memory 570. Computer programs can also be received from the baseband processor 610 and stored in the main memory 565 or in the secondary memory 570, or executed upon receipt. Such computer programs, when executed, enable the system 550 to perform the various functions of the present invention as previously described. For example, the main memory 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. An asynchronous network-on-chip (NOC) comprising:
a plurality of intellectual property (IP) blocks arranged on individual adjacent tiles;
an asynchronous node positioned on each of the plurality of IP blocks;
a plurality of input ports and output ports located on each asynchronous node and configured for communicating with adjacent asynchronous nodes on adjacent tiles; and
a processor input port and a processor output port located on each asynchronous node and configured for communicating with a processing unit.

2. The asynchronous NoC of claim 1, wherein the processor input port and processor output port are configured to communicate with an asynchronous processing unit (APU).

3. The asynchronous NoC of claim 1, wherein the processor input port and processor output port are configured to communicate with a synchronous processing unit (SPU).

4. The asynchronous NoC of claim 3, wherein the processor input port of the asynchronous node communicates with the SPU via an synchronous-to-asynchronous first-in-first-out (FIFO) buffer, and wherein the processor output port of the asynchronous node communicates with the SPU via an asynchronous-to-synchronous FIFO buffer.

5. The asynchronous NoC of claim 4, wherein the IP blocks configured to communicate with SPUs are arranged on a single die adjacent to the IP blocks configured to communicate with APUs.

6. The asynchronous NoC of claim 5, further comprising a plurality of NoCs arranged as individual dies and connected in a three-dimensional space.

7. The asynchronous NoC of claim 1, wherein the asynchronous node further comprises at least one asynchronous input port for routing data from an input channel to a plurality of output channels.

8. The asynchronous NoC of claim 1, wherein the asynchronous node further comprises at least one asynchronous output port for routing data from a plurality of input channels to an output channel.

9. The asynchronous NoC of claim 1, where the input ports and output ports of the asynchronous node communicate via Chronos channels.

10. A method of fabricating an asynchronous network-on-chip (NOC), comprising the steps of:
arranging a plurality of intellectual property (IP) blocks on individual adjacent tiles;
positioning an asynchronous node on each of the plurality of IP blocks;
forming a plurality of input ports and output ports on each asynchronous node, the plurality of input ports and output ports configured for communicating with adjacent asynchronous nodes on adjacent tiles;
forming a processor output port on each asynchronous node, the processor output port configured for transmitting data to a processing unit; and
forming a processor input port on each asynchronous node, the processor input port configured for receiving data from the processing unit.

11. The method of claim 10, further comprising connecting the processor input port and processor output port with an asynchronous processing unit (APU).

12. The method of claim 10, further comprising connecting the processor input port and processor output port with a synchronous processing unit (SPU).

13. The method of claim 12, further comprising connecting the processor output port with the SPU via a synchronous-to-asynchronous first-in-first-out (FIFO) buffer, further comprising connecting the processor input port with the SPU via an asynchronous-to-synchronous FIFO buffer.

14. The method of claim 10, further comprising arranging the at least one IP block configured to communicate with the SPU on a single die adjacent to the IP blocks configured to communicate with the APU, such that the SPU and APU communicate via their respective asynchronous nodes.

15. The method of claim 14, further comprising connecting a plurality of NoCs configured as individual dies in a three-dimensional space.

16. The method of claim 10, further comprising routing data on the asynchronous node from an input channel to a plurality of output channels via an asynchronous input port.

17. The method of claim 10, further comprising routing data on the asynchronous node from a plurality of input channels to an output channel via an asynchronous output port.
